(19) United States
(12) Patent Application Publication
(10) Pub. No.: US 2003/0071404 A1
(43) Pub. Date: Apr. 17, 2003

(54) Retractable workpiece-positioning device, such as silva stop

(76) Inventor: Andrew G. Cairns, Philadelphia, PA (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/261,898

(22) Filed: Oct. 1, 2002

Related U.S. Application Data
(60) Provisional application No. 60/326,360, filed on Oct. 1, 2001.

(51) Int. Cl. B23Q 1/25

(52) U.S. Cl. 269/74

(57) ABSTRACT

In one aspect, a device for positioning a workpiece with respect to a reference point is provided, the device including a first portion fixed with respect to the reference point; a second portion mounted on the first portion for movement with respect thereto, the second portion having a workpiece contact surface selectively movable between a retracted position and an extended position engaging a workpiece at a predetermined distance from the reference point. A method of processing workpieces and a method of positioning workpieces are also provided.

### CROSS-REFERENCE TO RELATED APPLICATION

This application claims the benefits of the filing date of the U.S. Provisional Patent Application No. 60/326,360 filed Oct. 1, 2001, the disclosure of which is incorporated herein by reference.

### FIELD OF THE INVENTION

The present invention relates to the field of processing of workpieces and in particular, a workpiece-positioning device and a related method(s) for positioning of a workpiece.

### BACKGROUND OF THE INVENTION

Precision metal processing, such as cutting and grinding, is a common methodology for manufacturing metal parts. Specifically, precision processing of the identical workpieces to produce multiples of the same part is an area of specialization for many metalworking companies. Multiple processing of identical workpieces typically requires identical positioning of the workpieces before cutting or grinding. Thus, the processing of identical workpieces requires reproducible workpiece set up.

Further, the processing of multiple workpieces is often done on automatic milling or cutting machines, which are very expensive. The machine tools required for such processing are also expensive. Therefore, the economic use of the precision tools and automatic machines requires a maximization of the operational periods. Consequently, a minimization of the time allotted to workpiece setup, along with reproducibility of the workpiece positioning, is essential.

Various methods of establishing a zero position for a workpiece are known in the art. One methodology involves the use of devices dedicated to each batch of workpieces. For example, a milling machine vise may be modified to support each workpiece in a particular position. If the vise is not moved relative to the tool, each workpiece is machined in the same manner by repeating the tool path. The setup time is minimized. However, the dedicated precision milling vises are expensive and therefore their use for smaller batches of workpieces is non-economical. For certain metal processing applications, the use of dedicated workpiece-holding devices, such as “tombstone” modules is common. An example of such device is described in U.S. Pat. No. 5,516,086. However, as with the dedicated vises, the use of dedicated workpiece-holding devices for smaller batches may be prohibitively expensive.

Use of workpiece positioning devices that do not require the dedication to each batch of workpieces is an alternative to dedicated vises and other similar devices. For example, in milling and grinding applications that typically utilize holding a workpiece in a vise, the workpiece-positioning device may be mounted on a fixed surface of the vise, such as its top or side surfaces or a fixed jaw. Such vise-mounted positioning devices of the prior art usually require modification of a precision vise to attach the device. Typically, holes are drilled and tapped into the surface of the vise to secure the positioning device to the vise by a screw or like attachment.

A number of workpiece-positioning devices have been proposed in the prior art. U.S. Pat. No. 6,029,967 to Wolfe describes a work stop located on a fixed jaw of a double vise. The work stop of Wolfe does not require a dedicated vise. However, the work stop of Wolfe may be used only with a vise having a jaw specially designed to attach the work stop. Other examples are disclosed, for example, in U.S. Pat. No. 5,996,986 to Ewing, U.S. Pat. No. 5,197,721 to Ruberg, and U.S. Pat. No. 4,030,718 to Philipoff. These devices have workpiece-locating elements that enter the opening between the jaws of the vise to contact a workpiece, thus preventing a lateral movement of the workpiece until the vise jaws can be closed in the workpiece position defined by the position of the workpiece-locating element of the device. After the processing operation is completed, the ready part is removed from the vise and replaced with another workpiece.

In all of these prior art devices, the workpiece-locating element remains in contact with the workpiece during the milling or cutting operation. Therefore, these devices and other known workpiece-positioning devices of the prior art do not allow processing of the workpiece in the area of contact between the locating element and the workpiece since the locating element prevents the machine tool from operating in such area of contact.

For example, in machining operation, if the workpiece must be machined on all sides, a typical method of machining on all sides of the workpiece involves the use of measured spacer blocks. The spacer block is placed between the workpiece and a fixed stop to establish the zero position for the workpiece. The spacer block is removed; the workpiece is clamped in a vise and machined. While this methodology is commonly used, the removal of the spacer block may change the position of the part, often requiring repositioning of the part. Also, to ensure proper holding strength and positioning, a substantial area of surface contact between the spacer block and the work piece is usually required. However, a large area of surface contact often results in false positioning due to uneven profile of the respective contact surfaces. Another disadvantage related to the use of the spacer blocks involves operator safety. The removal of the blocks is typically performed by hand, sometimes resulting in the injury known as a “pinch point.” Finally, the set up and removal of the spacer blocks takes time, increasing the downtime of the tools and machinery.

Thus, there is a need for a workpiece-positioning device that allows fast and reproducible setup of a workpiece, reliable and accurate positioning, improves operator safety, and permits processing of all sides of the workpiece.

### SUMMARY OF THE INVENTION

In accordance with one preferred aspect, the present invention addresses these needs by providing a device for positioning a workpiece with respect to a reference point that includes a first portion fixed with respect to the reference point; a second portion mounted on the first portion for movement with respect thereto, the second portion having a workpiece contact surface selectively movable between a retracted position and an extended position engaging a workpiece at a predetermined distance from the reference point. Preferably, the first and second portions move in sliding contact with one another along a longitudinal axis. The first and second portions of the device of this aspect of the invention are connected by a biasing element that biases the first and second portions towards the retracted position.

Preferably, the biasing element is a coil spring. The first portion may be slidably received within a bore in the second portion extending along the longitudinal axis. Preferably, the coil spring extends within the first portion.

The preferred device further includes a locking element for locking the first and second portions in the extended position. The locking element is engaged to the second portion for sliding movement therewith. Preferably, the locking element is attached to the second portion. The locking element may engage the first portion via relative rotation of the first and second portions about the longitudinal axis. The rotation about the longitudinal axis may lock the first and second portions in the extended position.

In the preferred embodiment of this aspect of the invention, the locking element is a locking pin extending radially into the bore of the second portion. The first portion may include a circumferential groove for engaging the locking pin in the extended position. The first portion may also include a longitudinally extending groove that engages the locking pin for sliding movement along the longitudinal axis. Preferably, the circumferential groove and the longitudinally extending groove are parts of a continuous slot for guiding the locking pin between the extended position and the retracted position. In the preferred embodiment, during retraction to a retracted position, the locking pin engages the longitudinally extending groove, thus preventing relative rotation of the first and second portions around the longitudinal axis.

In the preferred embodiment, the coil spring has a first end coupled to the locking pin and a second end coupled to a coil-tensioning member fixed with respect to the first portion. The coil-tensioning member may be a stationary pin extending radially through the first portion. The coil spring is preferably partially tensioned in the retracted position to arrest the sliding movement of the second portion from the retracted position without actuation.

The device of the preferred embodiment of this aspect of the invention preferably further includes an attachment member for coupling the first portion to a reference element bearing the reference point. The fixed position of the first portion may be selectively changed to a different fixed position with respect to the reference point. Preferably, the selective change in the fixed position of the first portion is affected by selectively engaging the attachment member, which may be an integral part of the first portion, to the reference element. The reference element may be a stationary work stop having female threads and the attachment member may have male threads. The selective change in the position of the first portion relative to the stationary work stop may thus be accomplished by engaging the female threads of the stationary work stop to the male threads of the attachment member.

The sliding movement of the second portion along the longitudinal axis toward the extended position and the relative rotation of the first and second portions about the longitudinal axis to lock the first and second portion in the extended position may be actuated manually. For manual actuation, the second portion of the device may have a gripping surface.

The workpiece-positioning device of the preferred embodiment of this aspect of the invention may further include the stationary work stop and/or a vise for clamping a workpiece engaged in the extended position.

In accordance with another preferred aspect, the invention provides a device for positioning a workpiece with respect to a reference point, the device including a first part capable of being fixed with respect to the reference point, a second part slidably engaging the first part along an longitudinal axis and moveable from a retracted position to an extended position with respect to the first part, a locking element for releasably locking the first and second parts in the extended position, and a biasing element coupled to the first and second parts biasing the first and second parts toward the retracted position upon release of the locking element. The preferred biasing element is a coil spring. Preferably, the first part is slidably received within a bore in the second part extending along the longitudinal axis. Also preferably, the coil spring extends within the first part. The locking element is preferably formed on the second part and engages the first part by the relative rotation of the first and second parts about the longitudinal axis.

In the preferred embodiment, the locking element is a pin extending radially into the bore of the second part. Preferably, the first part includes a circumferential groove for engaging the locking pin; and the second part includes a longitudinally extending groove, wherein the locking pin engages the longitudinally extending groove during retraction to prevent the relative rotation of the first and second portions.

In accordance with yet another preferred aspect, the invention provides a method for working on a workpiece positioned with respect to a reference point, the method including:

fixing a first part with respect to the reference point;

moving a second part, which is moveably connected to the first part, from a retracted position with respect to the first part to an extended position away from the reference point and toward a desired location for the workpiece;

placing the workpiece at the extended position;

retracting the second part to the retracted position with respect to the first part;

working on the workpiece;

removing the workpiece; and

repeating steps (b) through (f) for at least one additional workpiece.

Preferably, the first part and said second part slidably move with respect to one another along the longitudinal axis. Preferably, in the method of this aspect of the invention, the first part and the second part extend along a line connecting the desired location of the workpiece and the reference point. Also preferably, the method further includes immobilizing the workpiece after it is placed in the extended position. The preferred immobilizing step includes clamping the workpiece in a vise. The preferred working step includes milling the workpiece. Preferably, the method of this aspect of the invention further includes adjusting the fixed position of the first part to a different fixed position with respect to the reference point.

In accordance with yet another preferred aspect, the invention provides a method for positioning a workpiece with respect to a reference point, including:

fixing a first part with respect to the reference point;

moving a second part, which is moveably connected to the first part, from a retracted position with respect to the first part to an extended position away from the reference point and toward a desired location for the workpiece;

placing the workpiece at the extended position.

Preferably, in the method of this aspect of the invention, the first part and the second part extend along a line connecting the desired location of the workpiece and the reference point. Yet more preferably, the first part and the second part slidably move with respect to one another along the longitudinal axis. The method may further include immobilizing the workpiece at the extended position, with the immobilizing step preferably including clamping the workpiece in a vise.

### BRIEF DESCRIPTION OF THE DRAWINGS

A more accurate appreciation of the subject matter of the present invention and the various advantages thereof can be realized by reference to the following detailed description, which makes reference to the accompanying drawings in which:

FIG. 1A shows a diagram of operation of the device/method of the preferred aspect of the invention;

FIG. 1B is a flow diagram of the operation of the device/method of the preferred aspect of the invention;

FIG. 2 shows the components of the workpiece-positioning device in accordance with the preferred embodiment of the invention;

FIG. 3A shows a side view of the guide shaft of the device of FIG. 2, with the length of the guide shaft extending along the longitudinal axis XX′;

FIG. 3B shows a cross-sectional view, at the line AA, of the guide shaft 120 in the direction X′X along the longitudinal axis;

FIG. 4A shows a side view of the contact barrel of the device of FIG. 2, with the length of the contact barrel extending along the longitudinal axis XX′;

FIG. 4B shows a view of the contact barrel parallel to the longitudinal axis in the direction XX′;

FIG. 4C shows a view of the contact barrel parallel to the longitudinal axis in the direction X′X;

FIG. 5 shows a side view of the assembled device of FIG. 2, with the contact barrel slidably moved along the longitudinal axis in the direction XX′;

FIG. 6 illustrates the conversion of the device of FIG. 2 between a retracted position and an extended position;

FIGS. 7A and 7B illustrate a spring retainer, which one of the possible alternative components of the device of FIG. 2;

FIG. 8 illustrates, in a schematic form, a possible mode of cooperation of the work-piece positioning device with a fixed work stop and a vise.

### DESCRIPTION OF THE PREFERRED EMBODIMENTS

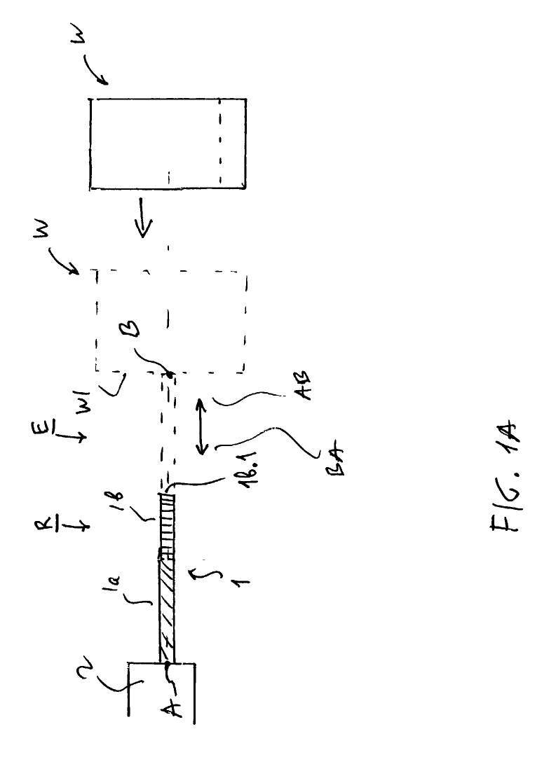

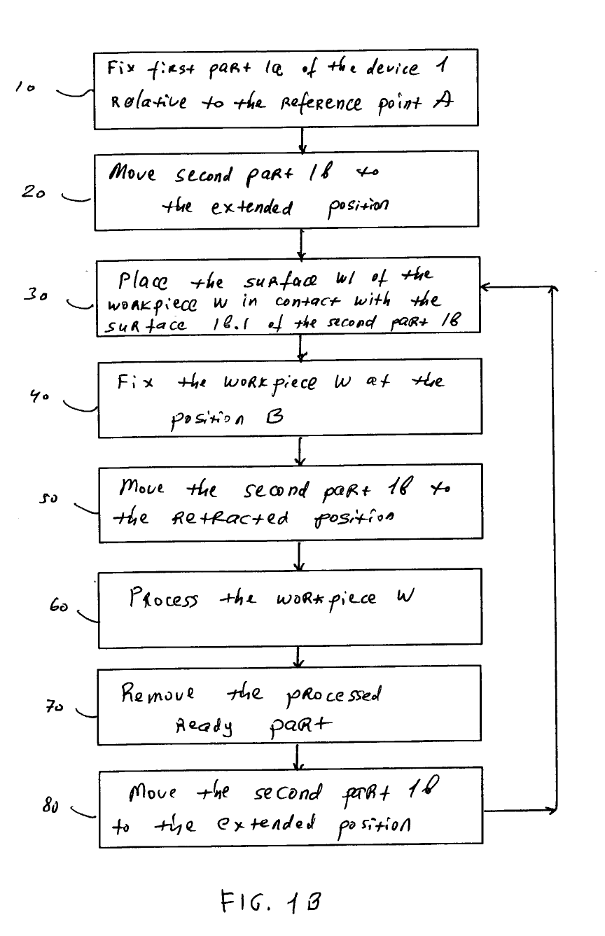

In accordance with one preferred aspect of the invention, there is provided a workpiece-positioning device 1 and the related method(s) illustrated in FIGS. 1A and 1B. Suppose, a workpiece W, which has a surface W1, should be placed at a pre-determined position B with respect to a reference point A located on a fixed element 2 (FIG. 1A). Preferably, the workpiece-positioning device 1 has a first part 1a and a second part 1b movably coupled to the first portion 1a. The location of the first part 1a is fixed with respect to the reference point A. The first part 1a may be attached to the fixed element 2, directly or indirectly, or may be coupled thereto in any other way. The position of the first portion 1a with respect to the reference point A may be fixed permanently or adjustably. For example, the position of the first part 1a may be adjusted from one fixed position to another fixed position for a new processing operation.

The second part 1b bears a workpiece-contact surface 1b.1. The second part 1b may be moved relative to the first part 1a between a retracted position R in which the workpiece-contact surface 1b.1 is nearer the reference point A and an extended position E in which the workpiece-contacting surface 1b.1 is at the pre-determined position B.

FIG. 1B illustrates one variant of operation of the device 1. The location of the first part 1a is fixed in place with regard to the reference point A (FIG. 1B, Step 10). The second part 1b is moved relative to the fixed first part 1a in the direction of the pre-determined location B (Step 20). The workpiece W is positioned in the extended position of the second part 1b, with the surface W.1 placed in contact with the workpiece-contact surface 1b.1 (Step 30). The workpiece W is clamped or otherwise fixed at the pre-determined position B (Step 40). The second part 1b is retracted back in the direction BA of the reference point A (Step 50). The workpiece W, including the surface W.1, is processed (Step 60). After processing, the ready part is removed (Step 70). The second part 1b is again extended again in the direction AB to provide an indication of the position B for another workpiece W (Step 80).

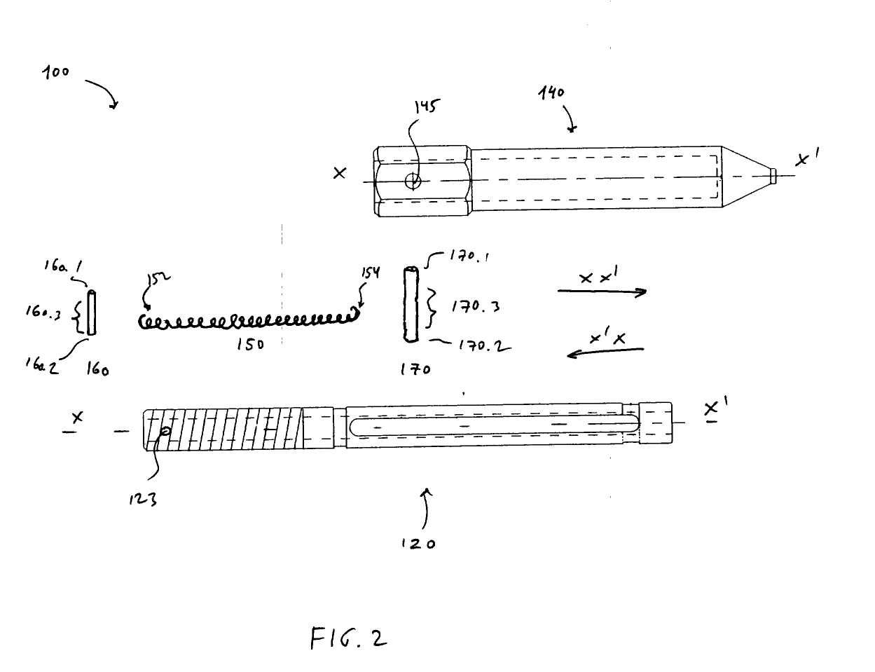

One example of a workpiece positioning device is the preferred embodiment shown in FIGS. 2-8, and designated by the reference numeral 100. It should be understood that various other embodiments of the devices may be used with the novel features of the present invention and thus the device 100 is intended only by way of illustration. In FIGS. 2-5, the plane of the paper is designated as P and a longitudinal axis as XX′.

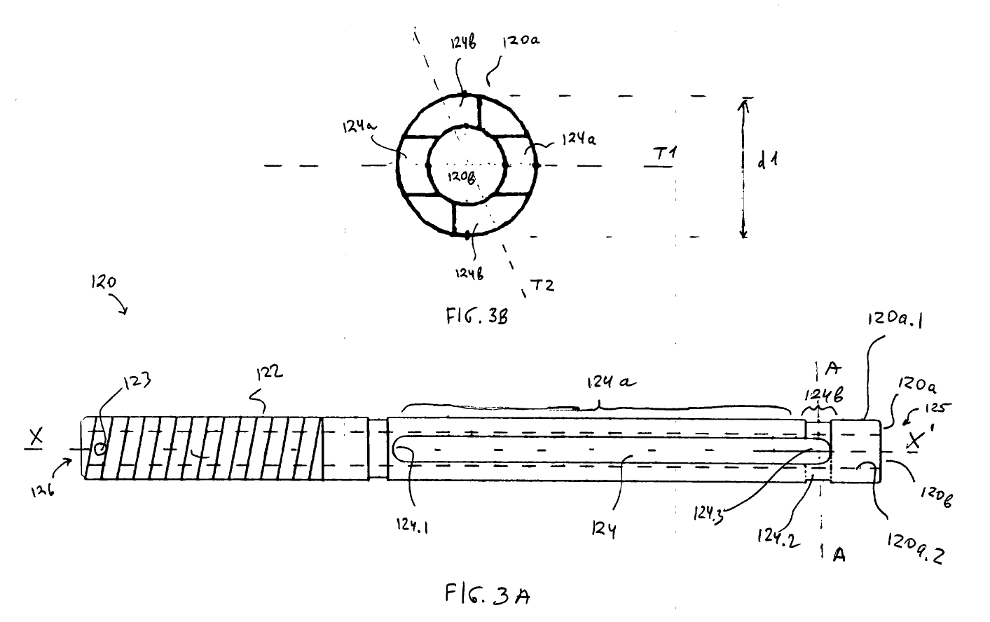

The device 100 in accordance with the preferred embodiment of the invention has two major parts: a guide shaft 120 and a contact barrel 140 (FIG. 2). Both the shaft 120 and the barrel 140 have a cylindrical shape, although it should be of course understood that any other matching shapes or shapes that allow movement of the major parts relative to one another are also contemplated. The device 100 also includes a coil spring 150, a sliding/locking pin 160, and a stationary pin 170. The guide shaft 120 has a barrel-engagement end 125 and an attachment end 126 (FIG. 3A). The guide shaft 120 is substantially cylindrical and extends along the longitudinal axis XX′. As seen in FIGS. 3A and 3B, a substantially cylindrical wall 120a defines an opening 120b through the length of the shaft 120. The wall 120a has an external circumferential surface 120a.1 with a circumference diameter d1 and an internal circumferential surface 120a.2. The external circumferential surface 120a.1 bears male threads 122 for engaging female threads (not shown) of a fixed stop to attach the guide shaft 120 to the fixed stop. A hole 123 radially traverses the wall 120a in the area of the threads 122. The dimensions of the radial hole 123 allow insertion and retention of the stationary pin 170 therein. Also, it should be understood that the hole 123/the pin 170 cooperation might involve square, hexagonal, or any other shape.

A slot 124, which cooperates with the sliding/locking pin 160 in the assembled device 100, extends from a first slot end point 124.1 through a slot turning point 124.3 to a second slot end point 124.2. The slot 124 includes a longitudinal groove 124a and a circumferential groove 124b. The longitudinal groove 124a extends along the longitudinal axis XX′ from the first slot end point 124.1 to the slot turning point 124.3. The circumferential groove 124b continues the longitudinal groove 124a in the direction substantially perpendicular to the longitudinal axis XX′, extending circumferentially from the slot turning point 124.3 and ending at the second slot end point 124.2. FIG. 3B shows a cross-sectional view of the guide shaft 120 in the direction X′X along the longitudinal axis, the cross-section located at the line AA. As seen in FIG. 3B, the longitudinal groove 124a is radially traversing the wall 120a and the opening 120b along the line T1. The circumferential groove 124b is radially traversing the wall 120a and the opening 120b along the traversing line T2.

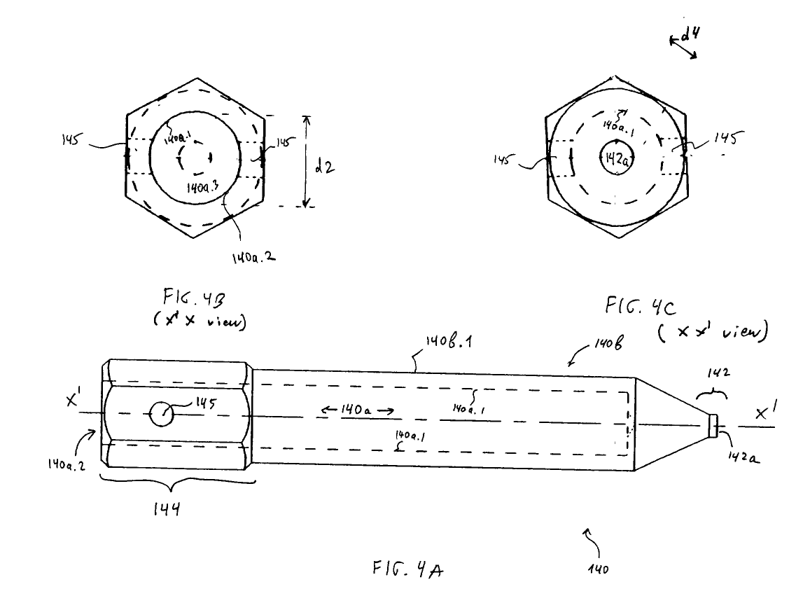

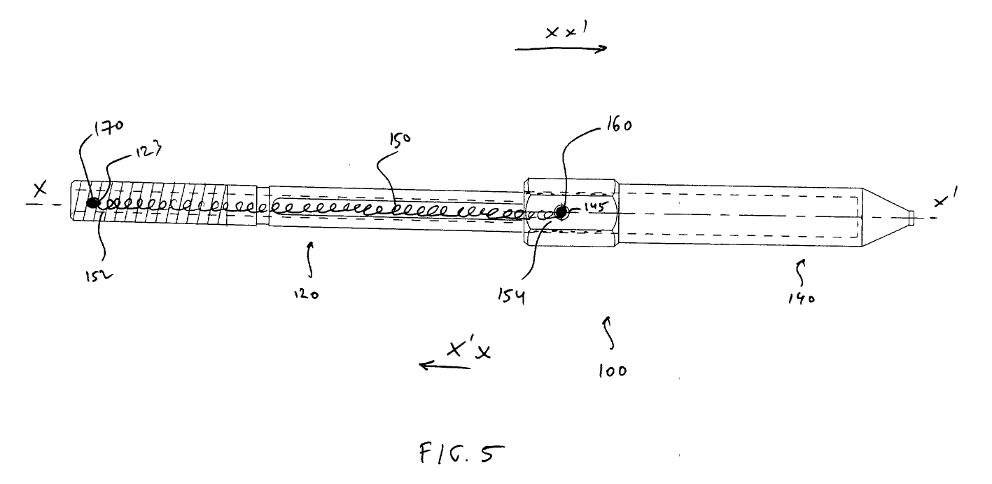

FIGS. 4A-4C illustrate the structure of the contact barrel 140, which is slidably movable with respect to the guide shaft 120. The barrel 140 has a substantially circumferential bore 140a with an internal circumferential surface 140a.1 (FIGS. 4A and 4B). The surface 140a.1 extends along the longitudinal axis XX′ from a bore opening 140a.2 to a bore end surface 140a.3. The internal circumferential surface 140a.1 has a circumference diameter d2 (FIG. 4B showing the view in the direction X′X), which permits the guide shaft 120 to be slidably received into the bore 140a. Preferably, the circumference diameter d1 of the external surface 120a.1 is close to the circumference diameter d2 of the internal surface 140a.1 to allow a stable sliding movement of the guide shaft 120 and the contact barrel 140 along the longitudinal axis XX′.

An external surface 140b of the contact barrel 140 includes an external circumference portion 140b.1. In the longitudinal direction XX′ from the portion 140b.1, the contact barrel 140 tapers to a contact area 142, which has a workpiece-contact surface 142a (FIGS. 4A and 4C). The surface 142a has a round shape, although of course any other shapes are also contemplated. The diameter d4 of the contact surface 142a (FIG. 4C showing the view in the direction X′X) is small to minimize workpiece contact error due to the imperfection in the surfaces of the raw workpieces.

In the longitudinal direction X′X from the circumference 140b.1, the contact barrel 140 includes a gripping area 144 of a hexagonal shape that facilitates hand gripping of the contact barrel 140. Of course, any other manner of facilitating gripping is also contemplated. A radial hole 145 is located at the gripping area 144. The diameter of the radial hole 145 allows insertion and retention of the sliding/locking pin 160 therein. It should be understood that the hole 145/the pin 160 cooperation might involve square, hexagonal, or any other shape.

Referring again to FIG. 2, the coil spring 150 has a first end 152 and the second end 154; the sliding/locking pin 160 has ends 160.1 and 160.2, and a central portion 160.3; and the stationary pin 170 has ends 170.1 and 170.2, and a central portion 170.3. Upon assembly of the device 100, the first end 152 of the spring 150 is intended to engage the central portion 170.3 of the stationary pin 170 and the second end 154 is intended to engage the central portion 160.3 of the sliding/locking pin 160.

Describing a non-limiting example of assembly of the device 100, the first end 152 of the coil spring 150 is placed around the central portion 170.3 of the stationary pin 170. The ends 170.1 and 170.2 of the stationary pin 170, with the attached spring 150, are inserted into the hole 123 of the guide shaft 120. After the insertion, the coil spring 150 lies inside the circumferential opening 120b with the second end 154 of the spring 150 extending into the longitudinal portion 124a of the slot 124. The barrel-engagement end 125 of the guide shaft 120 is then inserted into the bore 140a of the contact barrel 140, with the internal circumferential surface 120a.1 sliding across the internal circumferential surface 140a.1. The contact barrel 140 is moved longitudinally with respect to the shaft 120 until the location of the radial hole 145 matches the location of the second end 154 of the coil spring 150. The sliding/locking pin 160 is then inserted into the radial hole 145 and the second end 154 of the coil spring 150.

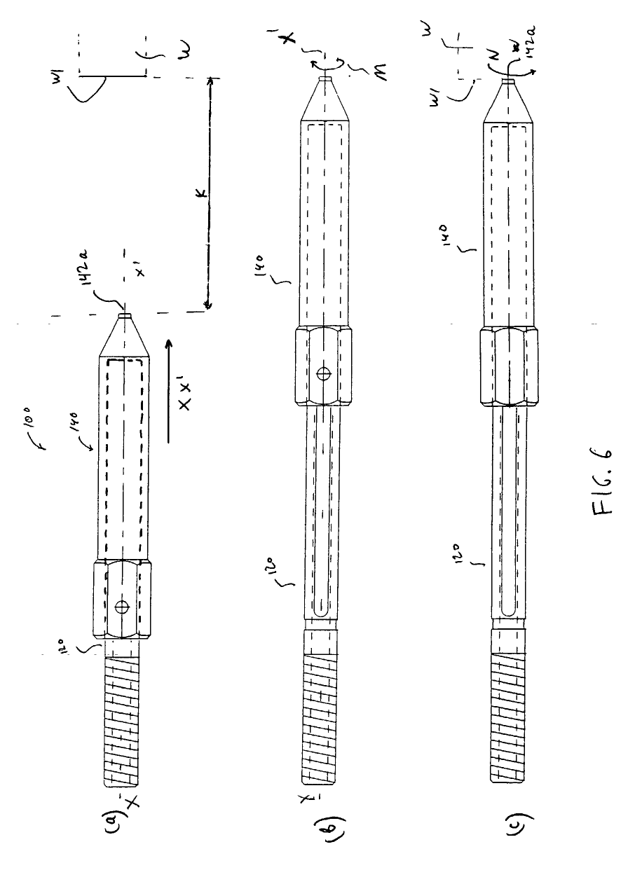

FIG. 5 shows the assembled device 100 with the contact barrel 140 moved relative to the guide shaft 120 along the longitudinal axis in the direction X′X. After assembly, the sliding/locking pin 160 is movably engaged to the coil spring 150. With the ends 160.1 and 160.2 of the pin 160 inserted in the radial hole 145, the sliding/locking pin 160 is also engaged to the contact barrel 140. Therefore, longitudinal movement of the contact barrel 140 moves the pin 160 and tensions the coil spring 150. The slot 124 guides the direction of movement of the pin 160 and therefore the contact barrel 140.

The coil spring 150 biases the contact barrel 140 in the X′X direction along the longitudinal axis. Without exertion of external force upon the contact barrel 140 in the direction XX′, the biasing force of the spring 150 biases the contact barrel 140 toward the guide shaft 120 in the direction X′X. The biasing of the contact barrel 140 brings the pin 160 in contact with the first slot end point 124.1 of the slot 124. Alternatively, depending on the dimensions of the shaft 120 and the barrel 140, the barrel-engagement end 125 of the guide shaft 120 comes in contact with the bore end surface 140a.3 of the bore 140a. In any event, the contact prevents the barrel 140 from further movement in the direction X′X. In this position, the tensioning of the coil spring 150 preferably remains sufficient to arrest a movement of the contact barrel 140 in the direction XX′ without external actuation or force. The engagement of the pin 160 in the slot 124 prevent relative rotation of the guide shaft 120 and the contact barrel 140 about the axis XX′. Such first stable position of the shaft 120/the barrel 140 relative to each may be called a retracted position of the device 100 (as well as for the barrel 140 and the workpiece-contacting surface 142a) and is shown in FIG. 6(a).

If an external force is applied to the contact barrel 140 in the longitudinal direction XX′ (for example, by a hand gripping the hexagonal portion 144), the barrel 140 moves in the direction XX′ following the external force. Automated actuation of the device 100 and other devices of the invention from the retracted position to the extended position (and back) is also contemplated. In this regard, for example, see U.S. Pat. No. 5,035,555, which is herein incorporated by reference in its entirety.

In the retracted position, the pin 160, being engaged in the longitudinal groove 124a, rests near or at the first slot end point 124.1 of the slot 124. Referring to FIG. 3A, the movement in the direction XX′ brings the pin 160 to the slot turning point 124.3. As seen in FIG. 6(b), the contact barrel 140 may then be moved circumferentially relative to the guide shaft 120 about the longitudinal axis (shown by arrow M) . Referring to FIGS. 3A and 3B, such circumferential movement guides the slot 160 along the circumferential groove 124b to the second slot end point 124.2. The circumferential direction of the groove 124b in combination with the biasing force provided by the coil spring 150 prevent the contact barrel 140 from retraction. Such second stable position of the shaft 120/the barrel 140 relative to one another along the axis XX′ may be called an extended position and is shown in FIG. 6(c). In the effect, the contact barrel 140 is locked the extended position unless an external force is applied.

In the extended position, the workpiece-contacting surface 142a marks a zero position for the workpiece W. The device 100 in the extended position may function as a stop limiting the movement of the workpiece and/or a zero position marker. The workpiece can be placed in contact with the surface 142a and fixed in place.

To unlock the device 100 allow processing of the workpiece, the contact barrel 140 is moved circumferentially about the longitudinal axis as shown by arrow N to remove the pin 160 from engagement in the circumferential groove 124b (FIG. 6(c)). Once the locking/sliding pin 160 reaches the slot turning point 124.3, no external force is required. The coil spring 150 biases the barrel 140 back to the retracted position (FIG. 6(a)).

Referring to FIG. 6(a), the gap k between the workpiece-contacting surface 142a and the zero-position surface W1 of the workpiece W permits operation of a tool, for example, an end mill or a cutter, on the workpiece W. The length of the gap k may be defined as a travel distance of the device in accordance with the preferred embodiment of the invention. The workpiece-positioning devices with any desired travel distances are contemplated. The preferred devices have travel distances of 1.45″, 1.55″, 1.65″, and 1.7″.

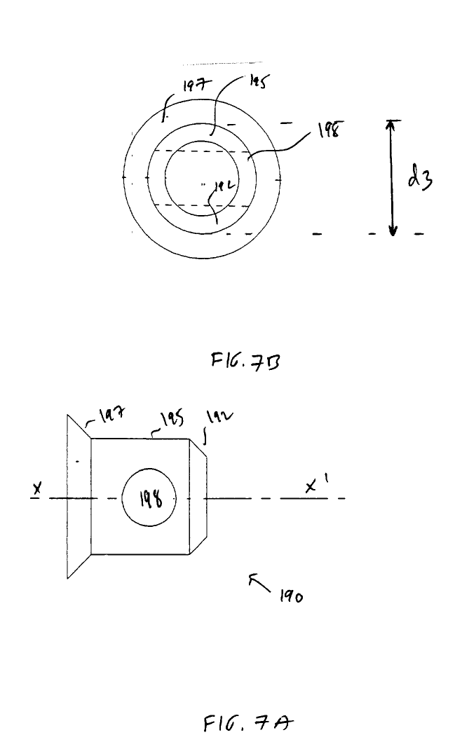

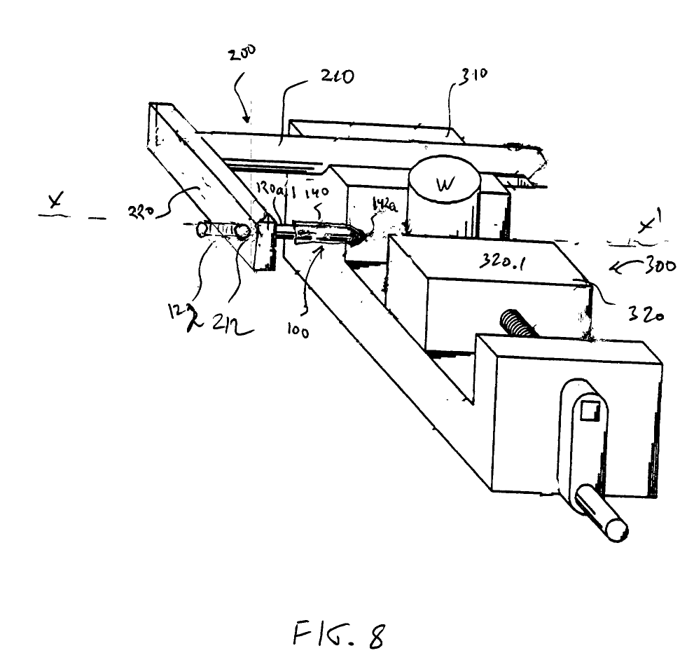

In one preferred variant, the stationary pin 170/the radial hole 123 for fixing the first end of the spring 150 to the guide shaft 120 may be replaced with a spring retainer 190 (FIGS. 7A and 7B). The retainer 190 includes a first tapered portion 192, a main portion 195 and a second tapered portion 197. A radial opening 198 traverses the main portion 195. The circumference of the main portion 195 has a diameter d3 (FIG. 7B) smaller than the diameter d2 of the guide shaft 120. The first end 152 of the coil 150 is passed through the radial opening 198 with attachment of the spring 150 to the retainer 190. The main portion 195 is inserted into the opening 120b of the guide shaft 120 at the attachment end 126. Once inserted, the retainer 190 substitutes the stationary pin 170 and the radial hole 123 to fix the position of the first end 152 of the spring 150. The use of the retainer 190 is more convenient assembly step than the insertion of the stationary pin 170.

The workpiece-positioning device may be connected to any fixed element commonly used in workpiece processing. With respect to the device 100 of the preferred embodiment of the invention, the fixed element having female threads may allow adjustable attachment of the guide shaft 120 by engaging the male threads 122 to the female threads of the fixed element.

A non-limiting example of the fixed element is a typical work stop used with milling vises. FIG. 8 illustrates one of many possible arrangements for using the device 100. The work stop 200 having a first arm 210 and a second arm 220 is mounted on a single jaw vise 300 (both are shown in highly schematic manner). The first arm 210 is attached to a fixed jaw 310 of vise 300. The top surface of a movable jaw 320 is designated 320.1.

The second arm 220 of the work stop 200 is perpendicular to the first arm 210 and attached thereto. The arm 220 has an opening 212 with female threads 214 (not shown) for engaging the male threads 122 on the external surface 120a.1 of the guide shaft 120.

The position of the guide shaft 120 is adjustably fixed with respect to the arm 220. The position of the guide shaft 120 along the longitudinal axis XX′ with respect to the opening 212 may be adjusted by engaging or disengaging the male threads 122 in the female threads 214. However, once the adjustment via the threads is made, the position of the guide shaft 120 remains fixed for any desired position of the workpiece W. FIG. 8 shows the device 100 is the retracted position. To position the workpiece W, the contact barrel 140 is moved in the direction XX′ along the longitudinal axis and locked in the extended position. The workpiece W is then placed in contact with the workpiece-contact surface 142a. It should be noted that FIG. 8 shows the contact surface 142a in contact with the workpiece below the top surface 320.1 of the vise's jaw 320. Stationary, non-retractable workpiece positioning devices may be used for such applications since the point of the contact cannot be machined anyway below the jaws of the vise. The device 100 is especially useful for positioning workpieces where the point of contact is above the surface 320.1.

Different types of vises and other workpiece-immobilizing devices may be used with workpiece-positioning devices of the invention. The suitable vises include, for example, horizontal vises, vertical vises, tilting vises, single jaw vises, double vises, and the like. Examples of suitable vises are disclosed in U.S. Pat. Nos. 6,044,544, 6,029,967, 6,012,712, and 5,501,440, which are incorporated herein by reference in their entirety. The workpiece-positioning devices of the invention may be used with various workpiece-processing machines, such as, flame cutting machines, milling machines, grinding machines, and the like, including highly automated, automatic, and manual machines. Non-limiting examples of suitable machines are described in U.S. Pat. Nos. 5,505,438 and 5,035,5545, which are incorporated herein by reference. The use of the workpiece-positioning devices of the invention is particularly preferred for processing multiples of identical workpieces, especially for use in vertical or horizontal CNC machining centers. The devices of the invention may be used for workpieces made from metal, plastic, or other materials.

The specific variant of the preferred embodiment of the invention is called a Silva Stop. The examples below describe the manufacturing and specification of the Silva Stop positioning device. The examples below illustrate the invention and are by no means limiting.

### EXAMPLE 1

Manufacturing of the Spring Retainer.

Cut 1018 CRS steel to desired length. Face one end flat and smooth, turn the cut material to the smaller tapered portion (0.105′ diameter) and the larger tapered portion to 45 degrees angle relative to the main portion of the spring retainer. Part off to length. Using fixture, drill spring hole in the main portion. Deburr, tumble, and inspect. Nickel-plate the retainer (0.0002″ per side). Inspect.

Dimensions of the spring retainer: diameter of the smaller tapered portion: 0.105″; diameter of the main portion: 0.125″; diameter of the larger tapered portion: 0.18″; diameter of the spring hole: 0.062″.

### EXAMPLE 2

Manufacturing of the guide shaft.

Cut a portion of seamless tubing (tempered stainless steel) to desired length. Face one end flat and smooth, chamfer, and deburr. Rotate part 180 degrees, finish turn length, chamfer, thread, groove, and deburr. Mill slot in 1^{st} side using fixture. Mill slot in 2^{nd} side using fixture. Deburr and tumble. Glass bead. Inspect. Nickel plate (0.0002′ per side). Inspect.

Dimension of the manufactured shaft: total length: 2.9″, thread length: 0.775″; travel distance: 1.7″; diameter of internal opening: 1.4″; external circumference diameter: 0.25″; width of the slot for a locking pin: 0102″; threads: 1/4-20.

### EXAMPLE 3

Manufacturing of the Contact Barrel.

Cut a section of 440-C stainless steel to desired length. Face one end flat and smooth, drill and ream (bore of 0.248″). Deburr. Rotate part 180 degrees, finish turn length using form tool. Drill & ream (dowel holes of 0.093″). Passivate. Etch logo. Inspect final product.

Dimensions: the total length of the barrel: 2.455″; the length of the bore along the longitudinal axis: 2.128″; the length of the gripping portion: 0.6″; the distance from the bore opening to the locking pin holes: 0.238″; the distance between sides of the hexagon of the gripping section: 0.375″; diameter of the workpiece-contacting surface: 0.09″; the external diameter of the circumference section: 0.365″.

### EXAMPLE 4

Specifications of the Coil Spring.

Commercially available precision extension spring: zinc-plated music wire spring (meets ASTM B-633). Rockwell hardness of the spring was C41-60. The hook ends are machined. The overall length: 1.03″; the length inside the hook ends: 1.00″; the spring's O.D.: 0.125″ (tolerance: +0.003″/−0.005″); the wire diameter: 0.016″; the load tolerance: 1.96 lbs; the initial tension: 0.20 lbs; the spring rate tolerance (lbs/inch) −+/−10%; and the deflection load at1.5 lbs/inch: 1.18″.

### EXAMPLE 5

Specifications of the Locking/sliding Pin.

Commercially available Camcar alloy steel dowel pin, heat-treated. Material: Camcar Textron (ISO 9000 certified); the pin diameter: 0.00375″; the pin length: 0.3750″; standard oversize: 0.0002″; the Rockwell surface hardness: C60-64; one end of the pin (chamfered) is beveled, one end is flat.

The advantages of the invention include, among others, an improvement in the work place safety (e.g., the elimination of the “spacer” blocks makes the “pinch point” injuries unlikely), more precise positioning of the workpieces, good part-to-part reproducibility, and ability to process all accessible surfaces of the workpiece.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A device for positioning a workpiece with respect to a reference point, the device comprising:
a first portion fixed with respect to said reference point;
a second portion mounted on said first portion for movement with respect thereto, said second portion having a workpiece contact surface selectively movable between a retracted position and an extended position engaging a workpiece at a predetermined distance from said reference point.

2. The device as set forth in claim 1, wherein said first and second portions move in sliding contact with one another along a longitudinal axis.

3. The device as set forth in claim 2, wherein said first and second portions are connected by a biasing element biasing said first and second portions towards said retracted position.

4. The device as set forth in claim 3, wherein the biasing element is a coil spring.

5. The device as set forth in claim 4, wherein said first portion is slidably received within a bore in said second portion extending along said longitudinal axis.

6. The device as set forth in claim 5, wherein said coil spring extends within said first portion.

7. The device as set forth in claim 6, further including a locking element for locking the first and second portions in the extended position.

8. The device as set forth in claim 7, wherein the locking element is engaged to said second portion for said sliding movement therewith.

9. The device as set forth in claim 8, wherein the locking element is attached to said second portion.

10. The device as set forth in claim 9, wherein the locking element engages said first portion by the relative rotation of said first and second portions about said longitudinal axis to lock the first and second portions in the extended position.

11. The device as set forth in claim 10, wherein said locking element is a locking pin extending radially into said bore of said second portion.

12. The device as set forth in claim 11, wherein said first portion includes a circumferential groove for engaging said locking pin in said extended position.

13. The device as set forth in claim 12, wherein said first portion includes a longitudinally extending groove for engaging said locking pin for said sliding movement along said longitudinal axis.

14. The device as set forth in claim 13, wherein circumferential groove and said longitudinally extending groove are parts of a continuous slot for guiding said locking pin between the extended position and the retracted position.

15. The device as set forth in claim 13, wherein said locking pin engages said longitudinally extending groove during retraction to prevent the relative rotation of said first and second portions around said longitudinal axis.

16. The device as set forth in claim 15, wherein said coil spring has a first end attached to said locking pin.

17. The device as set forth in claim 16, further including a coil-tensioning member fixed with respect to said first portion, said coil spring having a second end attached to the coil-tensioning member.

18. The device as set forth in claim 17, wherein said coil spring is partially tensioned in said retracted position, thereby arresting the sliding movement of said second portion from said retracted position without actuation.

19. The device as set forth in claim 18, further including an attachment member for coupling said first portion to a reference element bearing said reference point.

20. The device as set forth in claim 19, wherein said fixed position of said first portion may be selectively changed to a different fixed position with respect to said reference point; said attachment member effecting said selective change by selectively engaging said reference element.

21. The device as set forth in claim 20, wherein said attachment member is an integral part of said first portion.

22. The device as set forth in claim 21, wherein said reference element is a stationary work stop having female threads, said attachment member having male threads for engaging said female threads of said stationary work stop to permit said selective change in the position of said first portion relative to said stationary work stop.

23. The device as set forth in- claim 22, wherein said sliding movement of said second portion along the longitudinal axis toward the extended position is actuated manually.

24. The device as set forth in claim 23, wherein the relative rotation of said first and second portions about the longitudinal axis to lock the first and second portion in the extended position is actuated manually.

25. The device as set forth in claim 24, wherein said second portion has a gripping surface for said manual actuation.

26. The device as set forth in claim 25, wherein said coil-tensioning member is a stationary pin extending radially through said first portion.

27. The device as set forth in claim 26, further comprising said stationary work stop.

28. The device as set forth in claim 27, further comprising a vise for clamping a workpiece engaged in said extended position.

29. A device for positioning a workpiece with respect to a reference point, the device comprising:
a first part capable of being fixed with respect to the reference point;
a second part slidably engaging said first part along an longitudinal axis, said second part moveable from a retracted position to an extended position with respect to said first part;
a locking element for releasably locking the first and second parts in the extended position;
a biasing element coupled to said first and second parts biasing said parts toward said retracted position upon release of said locking element.

30. The device as set forth in claim 29, wherein the biasing element is a coil spring.

31. The device as set forth in claim 30, wherein said first part is slidably received within a bore in said second part extending along said longitudinal axis.

32. The device as set forth in claim 31, wherein said coil spring extends within said first part.

33. The device as set forth in claim 32, wherein the locking element is formed on said second part and engages said first part by the relative rotation of said first and second parts about said longitudinal axis.

34. The device as set forth in claim 33, wherein said locking element is a pin extending radially into said bore of said second part.

35. The device as set forth in claim 34, wherein said first part includes a circumferential groove for engaging said locking pin.

36. The device as set forth in claim 35, wherein said second part includes a longitudinally extending groove and wherein said pin engages said groove during retraction to prevent the relative rotation of said first and second portions.

37. A method for working on a workpiece positioned with respect to a reference point, the method comprising:
fixing a first part with respect to said reference point;
moving a second part, which is moveably connected to said first part, from a retracted position with respect to said first part to an extended position away from said reference point and toward a desired location for said workpiece;
placing the workpiece at said extended position;
retracting the second part to said retracted position with respect to said first part;
working on the workpiece;
removing the workpiece; and
repeating steps (b) through (f) for at least one additional workpiece.

38. The method as set forth in claim 37, wherein said first part and said second part extend along a line connecting said desired location of the workpiece and said reference point.

39. The method as set forth in claim 37, further comprising immobilizing said workpiece after it is placed in said extended position.

40. The method as set forth in claim 39, wherein said immobilizing step comprises clamping said workpiece in a vise.

41. The method as set forth in claim 37, wherein said first part and said second part slidably move with respect to one another along said longitudinal axis.

42. The method as set forth in claim 37, wherein said working step comprises milling the workpiece.

43. The method as set forth in claim 37, further comprising adjusting said fixed position of said first part to a different fixed position with respect to said reference point.

44. A method for positioning a workpiece with respect to a reference point, the method comprising:
fixing a first part with respect to said reference point;
moving a second part, which is moveably connected to said first part, from a retracted position with respect to said first part to an extended position away from said reference point and toward a desired location for said workpiece;
placing the workpiece at said extended position.

45. The method as set forth in claim 44, wherein said first part and said second part extend along a line connecting said desired location of the workpiece and said reference point.

46. The method as set forth in claim 44, further comprising immobilizing said workpiece at said extended position.

47. The method as set forth in claim 46, wherein said immobilizing step comprises clamping said workpiece in a vise.

48. The method as set forth in claim 44, wherein said first part and said second part slidably move with respect to one another along said longitudinal axis.
